(19) United States
(12) Patent Application Publication
(10) Pub. No.: US 2012/0188275 A1
(43) Pub. Date: Jul. 26, 2012

(54) MOBILE ELECTRONIC DEVICE

(75) Inventors: Tomohiro SHIMAZU, Daito-shi (JP); Naoyuki TAMAI, Daito-shi (JP); Makiko HOSHIKAWA, Daito-shi (JP); Kazuya TAKEMOTO, Daito-shi (JP)

(73) Assignee: KYOCERA CORPORATION, Kyoto (JP)

(21) Appl. No.: 13/357,380

(22) Filed: Jan. 24, 2012

(30) Foreign Application Priority Data
Jan. 24, 2011 (JP) 2011-012336

(51) Int. Cl. G09G 5/377; G09G 5/373

(52) U.S. Cl. 345/629

(57) ABSTRACT

A mobile electronic device and method is disclosed. A reduced image of a screen image comprising at least one icon is displayed on a display surface. The reduced image is overlapped on the screen image displayed on the display surface.

### CROSS-REFERENCE TO RELATED APPLICATION

The present application claims priority under 35 U.S.C. §119 to Japanese Patent Application No. 2011-012336, filed on Jan. 24, 2011, entitled “MOBILE TERMINAL DEVICE”. The content of which is incorporated by reference herein in its entirety.

### FIELD

Embodiments of the present disclosure relate generally to mobile electronic devices, and more particularly relate to a mobile electronic device comprising more than one display screen thereon.

### BACKGROUND

Along with an increasing trend toward multifunction capability in mobile electronic devices, content of application programs (referred to herein as applications) that can be executed on mobile terminals has increased. Thereby the number of icons used with these applications has also increased. A user may have to spend a significant amount of time and effort to select a desired icon.

### SUMMARY

A mobile electronic device and method is disclosed. A reduced screen image of a reduced screen comprising at least one icon is displayed on a display surface. The reduced screen image is overlapped on a screen image displayed on the display surface.

A mobile electronic device comprising a display screen and a display control module. The display control module is operable to display a reduced image of a screen image comprising at least one icon on the display surface. The reduced image overlaps the screen image displayed on the display surface.

A method for operating a mobile electronic device displays a reduced image of a screen image comprising at least one icon on a display surface. The method further overlaps the reduced image on the screen image displayed on the display surface.

A computer readable storage medium comprises computer-executable instructions for performing a method for operating a display screen. The method executed by the computer-executable instructions displays a reduced image of a screen image comprising at least one icon on a display surface. The method executed by the computer-executable instructions further overlaps the reduced image on the screen image displayed on the display surface.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1A is an illustration of a front view of a mobile phone 1 according to an embodiment of the disclosure.

FIG. 1B is an illustration of a side view of a mobile phone 1 according to an embodiment of the disclosure.

FIG. 2 is an illustration of a functional block diagram of a mobile phone 1 according to an embodiment of the disclosure.

FIG. 3 is an illustration of a screen group according to an embodiment of the disclosure.

FIG. 4A is an illustration of an example in which screen P2 is displayed on display surface 11c according to an embodiment of the disclosure.

FIG. 4B is an illustration of an example in which screen P5 is displayed according to an embodiment of the disclosure.

FIG. 5 is an illustration of a flowchart showing a process for transition of a screen group according to an embodiment of the discloser.

FIG. 6 is an illustration of a flowchart showing a process for transitioning a screen group from a transition according to an embodiment of the discloser.

FIG. 7A is an illustration of a state in which a reduced image group is overlapped on a second screen, and displayed on a display surface according to an embodiment of the discloser.

FIG. 7B is an illustration of a transition screen, on which a display surface is displayed according to an embodiment of the discloser.

FIG. 8 is an illustration of a flowchart showing a process for transition of the screen group according to an embodiment of the discloser.

FIG. 9A is an illustration of screen groups that are displayed on a display surface an icon is moved according to an embodiment of the discloser.

FIG. 9B is an illustration of screen groups that are displayed on a display surface when an icon is moved according to an embodiment of the discloser.

FIG. 9C is an illustration of screen groups that are displayed on a display surface when an icon is moved according to an embodiment of the discloser.

FIG. 10A is an illustration of screen groups that are displayed on a display surface when an icon is moved according to an embodiment of the discloser.

FIG. 10B is an illustration of screen groups that are displayed on a display surface when icon is moved according to an embodiment of the discloser.

FIG. 10C is an illustration of screen groups that are displayed on a display surface when an icon is moved according to an embodiment of the discloser.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, Global Positioning Systems (GPSs) or navigation systems, health equipment, display monitors, or other electronic device that uses a display screen or a touch panel for displaying information.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

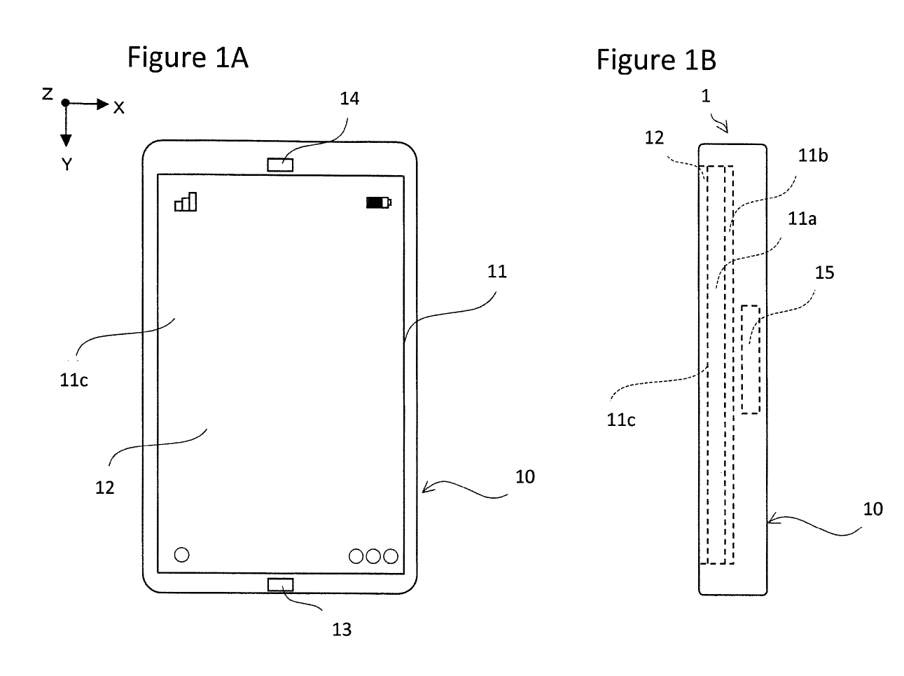

FIG. 1A and FIG. 1B show a front view and a side view of a mobile phone 1 respectively.

The mobile phone 1 comprises a cabinet 10, which comprises a front face and a rear face. A touch panel is located on the front face of cabinet 10. The touch panel comprises a display 11 that displays images, and a touch sensor 12 that is overlapped by display 11.

Display 11 comprises a liquid crystal panel 11a, and a panel backlight 11b that illuminates liquid crystal panel 11a. Liquid crystal panel 11a comprises a display surface 11c that displays images. Touch sensor 12 is located on display surface 11c. Moreover, instead of liquid crystal panel 11a, other display elements, such as an organic electroluminescent (EL), may be used.

The touch sensor 12 is operable to receive a selection input selecting a selected image from the display surface 11c, where the display control module (CPU 100) displays a selected screen corresponding to the selected image on the display surface 11c, when the selection input is received by the touch sensor 12. Touch sensor 12 is formed from a transparent sheet. Display surface 11c is visible through touch sensor 12. Touch sensor 12 provides, a first transparent electrode and a second transparent electrode, located in the form of a matrix. Touch sensor 12 is capable of detecting changes in capacitance between the first and second transparent electrodes. Touch sensor 12 detects the location on display surface 11c that is touched by the user (referred to herein as the “input location” or “location of a touch”), and outputs a location signal corresponding to the input location to a CPU 100, as described below. The touch sensor 12 may comprise, for example but without limitation, the capacitance-type touch sensor, an ultrasonic touch sensor, a pressure-sensitive touch sensor, or other touch sensor.

A user touching the display surface 11c means a user touching the display surface 11c, with a contact member, such as but without limitation, a pen, a finger, or other touching means. The term “display surface 11c is touched” means that a user touches an area on which an image of display surface 11c is projected on a surface of a cover covering the touch sensor 12. “Sliding” comprises operations in which the contact member is moved while it is in contact with the display surface 11c. “Flicking” means operations in which, while a contact member is in contact with display surface 11c, the contact member is moved for a short time and short distance only, after which the contact member is separated from display surface 11c.

A microphone 13 and a speaker 14 are located on the front face of cabinet 10. The user obtains audio from speaker 14 by his/her ear, and produces audio for microphone 13, thereby enabling a phone call.

The lens window of a camera module 15 is located on the rear face of cabinet 10. The image of the subject from the lens window is captured by camera module 15.

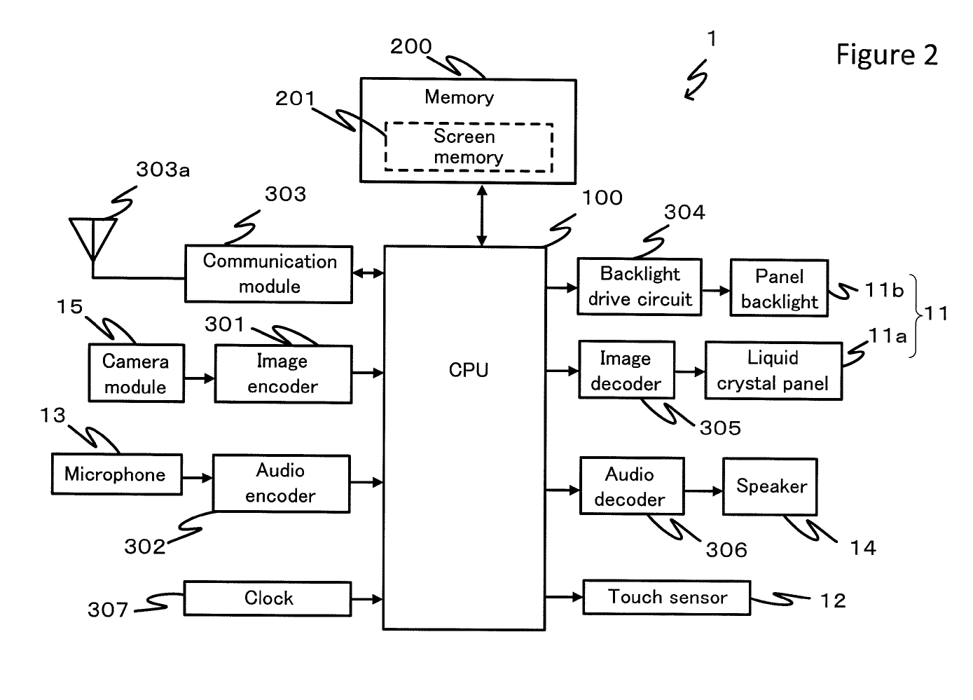

FIG. 2 is an illustration of a functional block diagram (system 200)of the mobile phone 1 according to an embodiment of the disclosure. The system 200 comprises a CPU 100, a memory 200, an image encoder 301, an audio encoder 302, a communication module 303, a backlight drive circuit 304, an image decoder 305, an audio decoder 306 and a clock 307.

Camera module 15 has image capture elements such as a charge-coupled device (CCD), and comprises a capture section that captures images. Camera module 15 digitizes the image capture signals output from the image capture elements, performs various corrections, such as gamma correction, on that image capture signal, and outputs it to image encoder 301. Image encoder 301 performs an encoding process on the image capture signal from camera module 15, and outputs it to CPU 100.

Microphone 13 converts the captured audio to an audio signal, and outputs it to audio encoder 302. Audio encoder 302, along with converting the analog audio signal from microphone 13 to a digital audio signal, performs an encoding process on the digital audio signal, and outputs it to CPU 100.

Communication module 303 converts information from CPU 100 to a radio frequency (RF) signal, and transmits it via an antenna 303a to a base station. Moreover, communication module 303 converts the RF signals received via antenna 303a to information and sends it to CPU 100.

Backlight drive circuit 304 supplies to panel backlight 11b a voltage signal corresponding to a control signal from CPU 100. Panel backlight 11b lights up depending on the voltage signal from backlight drive circuit 304, and illuminates liquid crystal panel 11a.

Image decoder 305 converts image signals from CPU 100 into analog or digital image signals that can be displayed on liquid crystal panel 11a, and outputs them to liquid crystal panel 11a. Liquid crystal panel 11a displays images corresponding to the image signals on display surface 11c.

Audio decoder 306 performs a decoding process on audio signals from CPU 100, and furthermore converts them to analog audio signals, and outputs them to speaker 14. Moreover, audio decoder 306 performs a decoding process on sound signals of various notification sounds from CPU 100, such as ringtones and alarms, and on audio signals, and moreover, converts them to analog sound signals, and outputs them to speaker 14. Speaker 14 plays back audio and notification sounds, etc., based on the audio signals and sound signals from the audio decoder 306.

Clock 307 measures time, and outputs a signal to CPU 100 corresponding to the measured time.

The memory 200 may be any suitable data storage area with suitable amount of memory that is formatted to support the operation of the system 200. Memory 200 is configured to store, maintain, and provide data as needed to support the functionality of the system 200 in the manner described below. In practical embodiments, the memory 200 may comprise, for example but without limitation, a non-volatile storage device (non-volatile semiconductor memory, hard disk device, optical disk device, and the like), a random access storage device (for example, SRAM, DRAM), or any other form of storage medium known in the art. Memory 200 comprises an image memory 201 for image display.

The memory 200 stores, a control program that provides control functionality to CPU 100. The control program comprises a control program for displaying on display surface 11c of display 11 image R (herein referred to as “reduced image group”), which is a reduction of the screen P (herein referred to as “screen group”) on which icon 500s are located. Icon 500 expresses content regarding which files and programs in mobile phone 1 can be processed. Processing content comprises, for example but without limitation, running applications, displaying data file and folder content, or other process.

Various data, such as but without limitation, information captured by camera module 15, information captured from the exterior through communication module 303, input information arising from user operation and obtained through touch sensor 12, or other data., are also stored in memory 200. The image data of screen group P is also stored in memory 200.

A location definition table is stored in memory 200. In the location definition table, the location of images displayed on display surface 11c and the content shown by the image are associated. The image comprises text and pictures, such as icon 500 and buttons. The content shown by the images comprises files, programs to be processed, etc.

A location relationship table is stored in memory 200. In the location relationship table, the location of reduced image group R and the location of screen group P are associated.

CPU 100 can specify a control program corresponding to the location signal from touch sensor 12, using the location definition table in memory 200. CPU 100, using the control program, can operate camera module 15, microphone 13, communication module 303, panel backlight 11b, liquid crystal panel 11a, speaker 14, etc. Various applications, such as phone call and electronic mail functions, can be performed.

CPU 100, as a display control module, is operable to display a reduced screen image R of a reduced screen comprising at least one icon 500 on the display surface 11c, the reduced screen image R overlapping a screen image displayed on the display surface 11c. CPU 100 as a display control module can control display 11 based on, for example, information input from the user through touch sensor 12. CPU 100 can output to backlight drive circuit 304 a control signal supplying a voltage to panel backlight 11b, to light up panel backlight 11b. CPU 100 can output an image signal to image decoder 305, to display an image on display surface 11c of liquid crystal panel 11a. CPU 100, by outputting to backlight drive circuit 304 a control signal to not supply a voltage to panel backlight 11b, turns off panel backlight 11b, and erases the image from display surface 11c of liquid crystal panel 11a. CPU 100 can control the display of display 11.

The CPU 100 as a display control module is further operable to display on the display screen 11c a first screen corresponding to a first image from among an image group comprising a plurality of images displayed on the display surface, and display the first image overlapping the image group on the first screen, when the first image is selected.

The CPU 100 as the display control module is further operable to move the icon 500 according to a relevant move input, when input to move the icon 500 within the first screen is received by the touch sensor 12, and display a second screen corresponding to a second image, when the icon 500 moves to a location of the second image within the image group in place of the first screen.

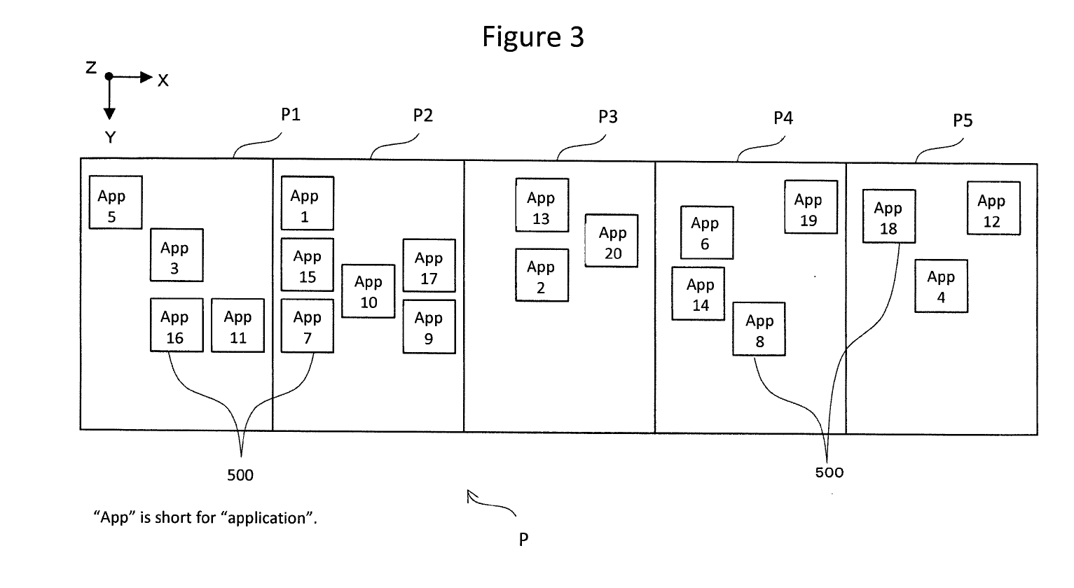

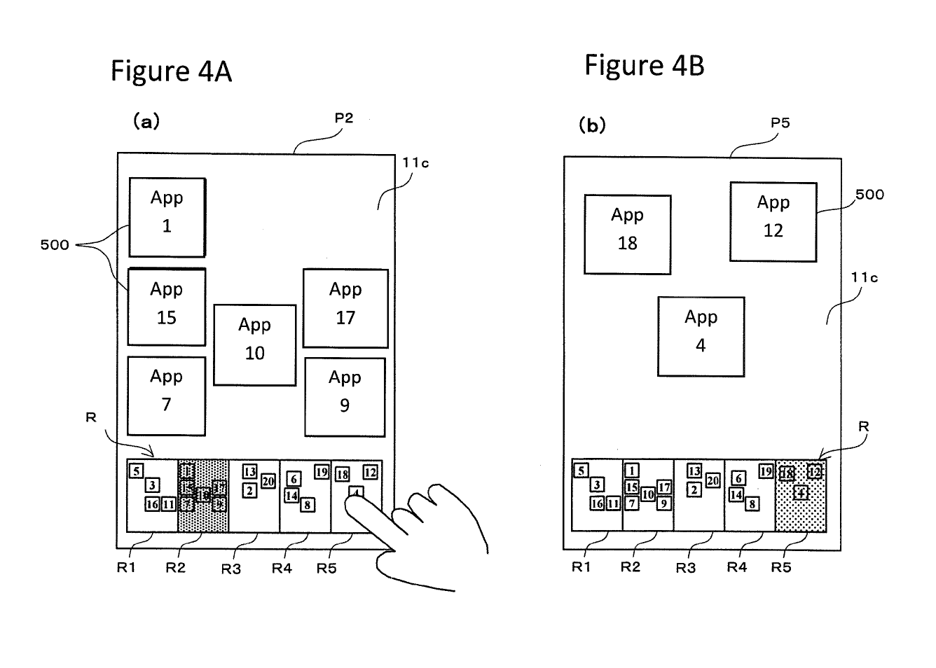

CPU 100, as a display control module, can display screen group P on display surface 11c. Screen group P has one screen, or two or more screens. FIG. 3 is an illustration of a screen group P. The screen group P comprises five screens P1 to P5. A size of each of the screens P1 to P5 can be almost the same within a display range of the display surface 11c (FIG. 1A). If the size of the screen group P is larger than the display range of display surface 11c, the CPU 100 displays one screen from among the screen group P on the display surface 11c. FIG. 4A and FIG. 4B are illustrations of diagrams showing a synthesis of a reduced image R of a screen group on the display surface 11c. FIG. 4A shows an example in which the screen P2 is displayed on the display surface 11c. FIG. 4B shows an example in which the screen P5 is displayed. The screen displayed within the display range of display surface 11c can be any one selected from among the screen group P1 to P5.

The CPU 100 as a display control module displays the reduced image group enlarged on the display surface 11c, when a prescribed input on the reduced image group is received by the touch sensor 12 as explained in more detail below.

When the screen group P is displayed on the display surface 11c, the CPU 100 maps image data of the screen group P to the image memory 201 for image display. The CPU 100 reads the image data of the screen group P from the memory 200, and expands the image data of the screen group in the memory 200. As shown in FIG. 3, the image data of the screen group P is arranged in an X direction, one line at a time. A prescribed area of the expanded data is extracted, and the extracted image data is mapped to a memory region in the image memory 201 (screen memory 201). The memory region corresponding to the display range is set to the image memory 201, and the image mapped to the memory region is displayed on the display surface 11c.

The CPU 100, as a display control module, can transit screens displayed on the display surface 11c, corresponding to operations by the user. When the user touches a specific reduced image from among the reduced image group R, the CPU 100 moves a screen range in which the screen is displayed according to the specific reduced image that is touched. In this manner, the screen displayed on the display surface 11c changes to the specific reduced image selected in the reduced image group R.

When the screen displayed on the display surface 11c changes, the CPU 100 moves an area extracted from an image data of the memory 200, one line at a time, in the X direction, while repeatedly mapping an image data of each line to a memory region in a reduced image memory of the screen memory. In this way, while the screen is transitioning/changing, a condition of transitioning screen is displayed on the display surface 11c. For example, when transitioning from the screen P2 to the screen P4, the screen P2 moves in a leftward direction, and continuing after screen P2, screen P3 moves in the leftward direction, as shown. Additionally, continuing after screen P3, screen P4 moves in the leftward direction, and a full area of screen P4 matches the display range, the movement stops, and all of screen P4 is displayed on display surface 11c.

The CPU 100 can produce the reduced image group R, in which screen group P is reduced, and can display reduced image group R on the display surface 11c. The reduced image group R is combined with the screen and displayed on the display surface 11c. The reduced image group R has a reduced image corresponding to each screen, and each reduced image comprises an icon 500 displaced on each screen. For example, the reduced image group R comprises areas R1 to R5 (herein referred to as “reduced images”), corresponding respectively to five screens (five screen images), P1 to P5. The reduced image R2 corresponds to the screen P2 (screen image P2). The icons 500 of the screen P2 are also displayed on the reduced image R2.

The reduced image group R displays, in each reduced image R1-R5, an icon 500 similar to the icon 500 displayed on each screen of the screen group P. Moreover, a location of the icon 500 on the reduced image group R corresponds to the location of the icon 500 on the screen group P. For this reason, the reduced image group R serves as a raw material for determining the icon 500 that are disposed on each screen of the screen group P. The reduced image group R can comprise images in which all the display content of the screen group P is comprised, or it can comprise images in which a section of the display content of screen group P is omitted. For example, if the icon 500 is shown as pictures and text, the color, or other feature of the icon 500 pictures and text may be omitted.

Based on locations of the icon 500 in each screen of the screen group P, and a shape of the pictures of the icon 500, the user may be able to understand the content of icon 500 displayed on each screen of the screen group P. The location of the icon 500 in the reduced image group R does not need to be associated with the icon 500 processing content. If association is not performed, even if the icon 500 on the reduced image group R is selected, the processing content shown by the icon 500 does not need to be run.

Moreover, images other than the icons displayed on each screen of the screen group P may be displayed. However, diagrammatically, in order to make it easier to see the reduced image group R, images other than icons may be omitted. Images other than icons, may comprise for example but without limitation, a background image of each screen in the screen group P, images displayed on each screen, or other image. Displayed images, may comprise for example but without limitation, an antenna image showing a signal strength, a clock image showing a time, an image such as a telephone showing incoming calls, a phone call image regarding unconfirmed incoming calls, and other image

The reduced image group R may be displayed according to a user operated timing or a predefined timing. For example but without limitation, when the display surface 11c is touched by the user, when an operation to move the icon 500 is performed, when an operation to display the reduced image group R is performed, or other operation, the reduced image group R may be displayed.

On the other hand, the display of the reduced image group R may be erased according to user operated timing or a predefined timing. For example but without limitation, when an operation to erase the display of the reduced image group R is performed, when an operation to move a screen is performed, when a function shown by icon 500 is performed, when there is an incoming call or an alarm notification, when display surface 11c is not touched for a prescribed time, or other operation, the reduced image group R may be erased.

When the display of the reduced image group R is erased in a state in which the screen is displayed on the display surface 11c, one or multiple marks may be displayed. As shown in FIG. 1 a dot mark is displayed on the lower left of the screen, and three dot marks are displayed on the lower right of the screen. On the display surface 11c, what is shown is that on the left side of the display screen one screen is currently displayed, and on the right side of the display screen three screens are currently displayed. By means of these marks, even if the reduced image group R is not being displayed, the user is able to easily grasp a number of screens and the location of the screen being displayed.

The CPU 100 may determine an input location within a reduced image R1-R5 of the reduced image group R, based on a location definition table. For example, when the icon 500 of “application 4” in the reduced image R5 of the reduced image group R is touched, the CPU 100 determines that the input location is on the reduced image R5 of reduced image group R.

The CPU 100, as a determination module, may determine a corresponding relationship between a location on the reduced image group R and a location on the screen group P based on a location relationship table. The location on the screen group P corresponding to the location on reduced image group R is determined. The screen in the screen group P corresponding to the reduced image R1-R5 in the reduced image group R is determined. For example, when the icon 500 of the “application 4” in the reduced image R5 of the reduced image group R is touched, the CPU 100 determines that the input location corresponds to the location of the icon 500 of the “application 4” in the screen group P. The CPU 100 also determines that the touched input location corresponds to the screen P5 in the screen group P when the reduced image R5 in the reduced image group R is touched.

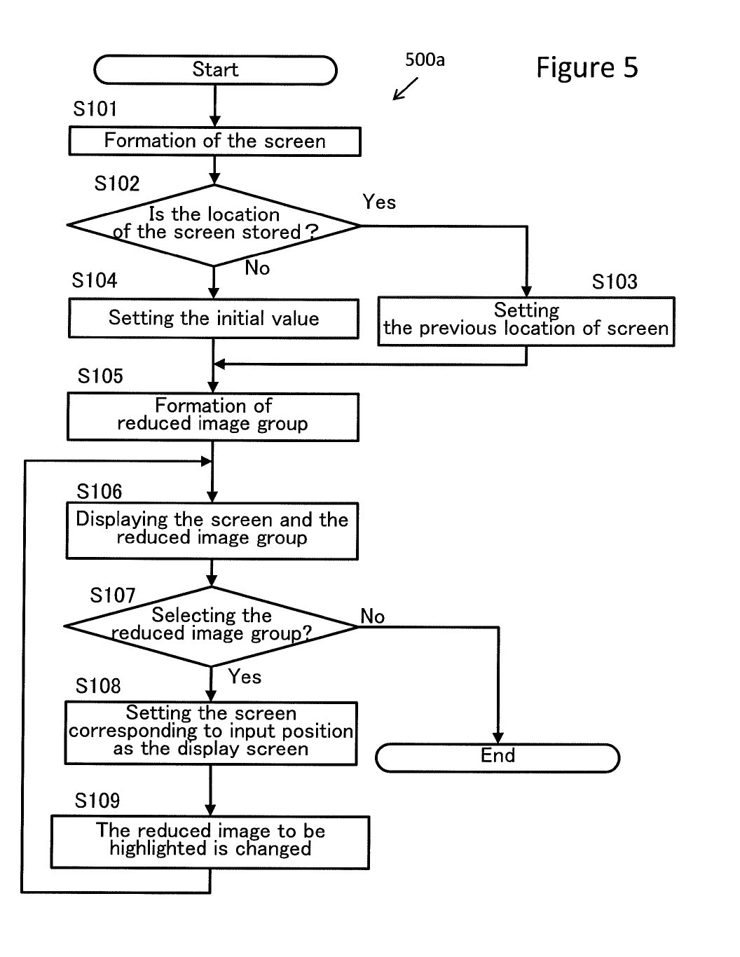

FIG. 5 is an illustration of a flowchart showing a process 500a for transition of the screen group P that can be performed by the CPU 100 according to an embodiment of the discloser. The various tasks performed in connection with the process 500a may be performed by software, hardware, firmware, a computer-readable medium having computer executable instructions for performing the process method, or any combination thereof. The process 500a may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 500a may include any number of additional or alternative tasks, the tasks shown in FIG. 5 need not be performed in the illustrated order, and process 500a may be incorporated into a more comprehensive procedure or process having additional functionality not described in detail herein. In practical embodiments, portions of the process 500a may be performed by different elements of the system 200 such as: the CPU 100, the memory 200, the image decoder 301, the audio encoder 302, the communication module 303, the backlight drive circuit 304, the image decoder 305, the audio recorder 306, the clock 307, the backlight drive circuit 11a, the panel backlight 11b, the touch sensor 12, etc. Process 500a may have functions, material, and structures that are similar to the embodiments shown in FIGS. 1-4. Therefore common features, functions, and elements may not be redundantly described here.

When power is turned on, or applications are terminated, etc., on the mobile phone 1, based on the information within a data file of the screen group P, the screen group P shown in FIG. 3 is formed in the memory 200 (task S101).

If the location of the screen in the screen group P displayed prior to the power down or prior to an application startup is stored in the memory 200 (task S102: YES), a previous screen location is set as a location of the display screen (task S103). For example, if the previous screen location was “2”, the screen P2 is set as the display screen. Moreover, if the previous screen location is not stored in the memory 200 (task S102: NO), the initial value is set as screen location “1”, and the screen P1 is set as the display screen (task S104).

Next, the reduced image group R of the screen group P is formed in the memory 200 (task S105). At this time, a reduced image corresponding to the display screen is determined based on the location relationships table. The reduced image thus determined is displayed and highlighted. For example, in FIG. 4A, the screen P2 is displayed, so the reduced image R2 is highlighted.

The reduced image group R, which has been formed, is combined with the screen P2, and the screen P2 and the reduced image group R are displayed on the display surface 11c (task S106).

It is then determined whether the reduced image group R has been selected or not (task S107). The user may view the reduced image group R, and search for an application to be started up from among the icon 500s displayed on each screen of the screen group P. Upon finding the application to be started up (for example, the “application 4”), the user touches the location of the icon 500 for the “application 4” on the reduced image group R, or the reduced image R5, containing the icon 500. The CPU 100 determines that the reduced image group R has been selected (task S107: YES).

It is then determined that the touched input location corresponds to the screen P5 of the screen group P. The screen P5 is then set as the display screen (task S108). The reduced image R5 indicated by the input location is highlighted on the display surface 11c (task S109).

The reduced image group R, in which the reduced image R5 is highlighted, is synthesized on the screen P5, and the synthesized screen group P is displayed on the display surface 11c (task S107). The screen transitions from the screen P2 to the screen P5. The reduced image R5 that is highlighted on the display surface 11c also transitions from the reduced image R2 to the reduced image R5.

For example, in the reduced image group R, the reduced image corresponding to the display screen of the screen group P is highlighted on the display surface 11c. The user is able to easily determine a location of the screen group P of the screen that is being displayed on the display surface 11c.

For another example, in the reduced image group R, a list of the icon 500s displayed on each screen of the screen group P is displayed. The user is able to easily grasp what kinds of icon 500 are displayed on screens other than the screen displayed on the display surface 11c. By viewing the reduced image group R, the user may find a desired icon 500.

According to one example, by touching a reduced image including a desired icon 500, the user may transition the display range to the screen that comprises the desired icon 500, without going to the inconvenience of moving each screen in the screen group P.

According to an embodiment, the mobile phone 1 may transition the screen group P based on an operation selected by the user on a transition screen.

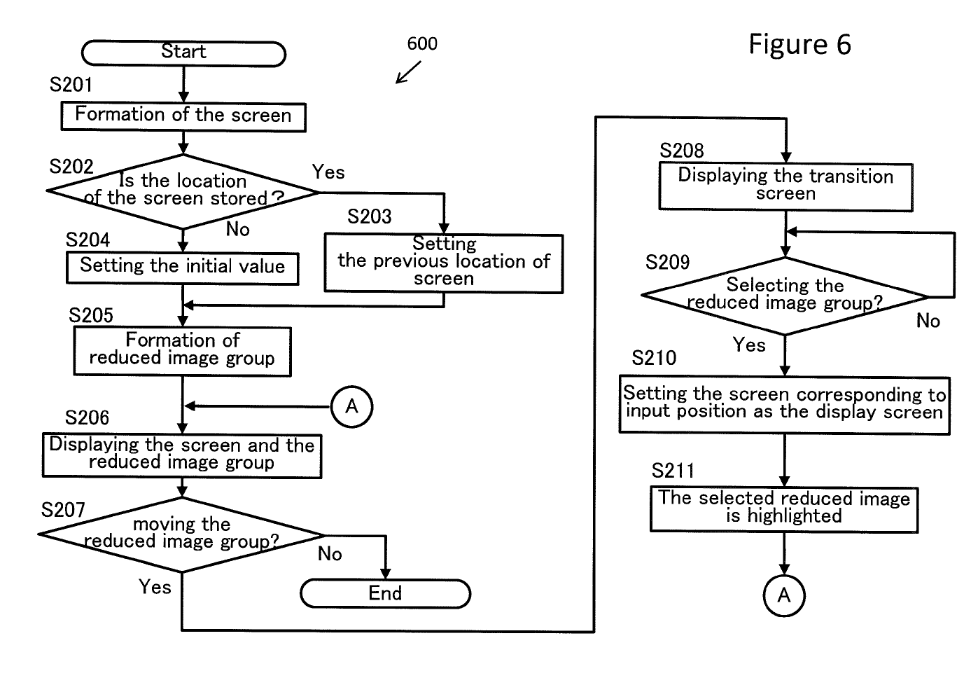

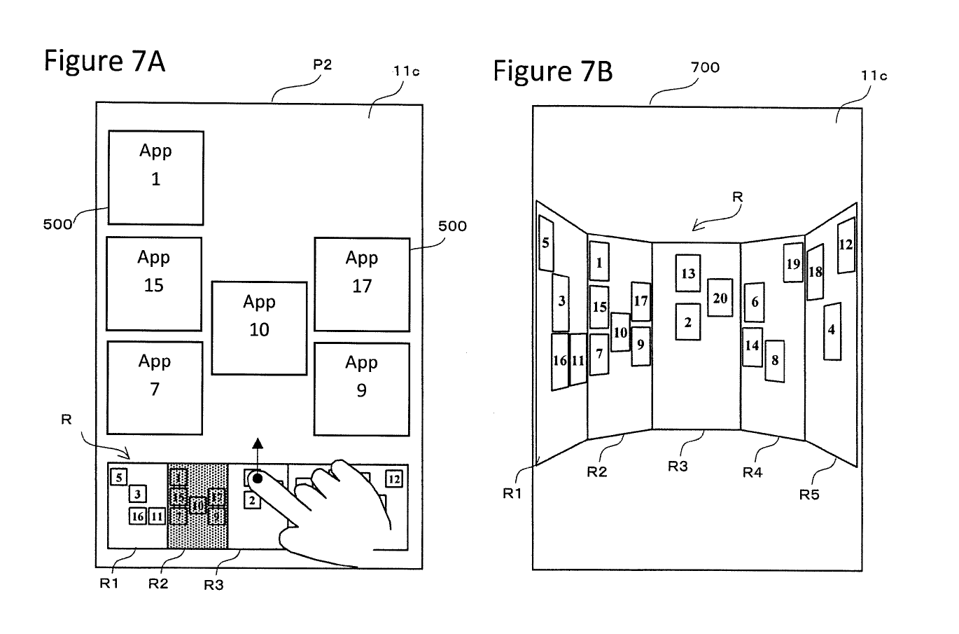

FIG. 6 is an illustration of a flowchart showing a process 600 for transitioning the screen group P from a transition screen 700 that can be performed by the CPU 100 group according to an embodiment of the discloser. FIG. 7A and FIG. 7B are illustrations of displaying the transition screen on the display surface. FIG. 7A is an illustration of a state in which the reduced image group R is overlapped on the second screen P2, and displayed on display surface 11c according to an embodiment of the discloser. FIG. 7B is an illustration of a transition screen 700, on which the display surface 11c is displayed according to an embodiment of the discloser.

FIG. 6 is an illustration of a flowchart showing a process 600 for transition of the screen group P that can be performed by the CPU 100. The various tasks performed in connection with the process 600 may be performed by software, hardware, firmware, a computer-readable medium having computer executable instructions for performing the process method, or any combination thereof. The process 600 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein. In practical embodiments, portions of the process 600 may be performed by different elements of the system 200 such as: the CPU 100, the memory 200, the image decoder 301, the audio encoder 302, the communication module 303, the backlight drive circuit 304, the image decoder 305, the audio recorder 306, the clock 307, the backlight drive circuit 11a, the panel backlight 11b, the touch sensor 12, etc. Process 600 may have functions, material, and structures that are similar to the embodiments shown in FIGS. 1-5. Therefore common features, functions, and elements may not be redundantly described here.

A data file of the screen group P shown in FIG. 3 is formed in the memory 200 (task S201).

If the previous screen location is stored in the memory 200 (task S202: YES), the previous screen location is set as the display screen location (task S203). Otherwise, if the display screen location is not stored in the memory 200 (task S202: NO), as an initial value, “1” is set as the display screen location (task S204).

The reduced image group R in the screen group P is formed (task S205), and as shown in FIG. 7A, the reduced image group R is synthesized on the screen P2. The synthesized screen group P is displayed on the display surface 11c (task S206).

If the user touches the reduced image group R, and a location of the touch is moved outside the range of the reduced image group R, the CPU 100 determines that an operation to move the reduced image group R is performed (task S207: YES).

By means of a move operation on the reduced image group R, it is replaced with the screen group P, and the transition screen 700 is displayed on the display surface 11c (task S208). On the transition screen 700, the icon 500 shown FIG. 7A is not displayed, instead an enlarged version of the reduced image group R is displayed. As shown in FIG. 7B, on the transition screen 700, the reduced image group R, which has been enlarged, is curved so that each reduced image group R is arranged along a curved surface rearward within a three-dimensional space. In this manner, the reduced image group R is enlarged on the display surface 11c, when a prescribed input on the reduced image group R is received. In this way, the reduced image group R is displayed with a large size, and the user is able to easily grasp the content of icon 500 comprised in reduced image group R.

When the user touches the reduced image group R on the transition screen 700, based on the location of the touch, it is determined that the reduced image group R has been selected (task S209: YES). Moreover, the screen in the screen group P corresponding to the location of the touch is determined, and the screen that has been determined is set as the display screen (task S210).

An area of the reduced image group R corresponding to the location of the touch is derived, and this reduced image is highlighted on the display surface 11c (task S211).

The reduced image group R is synthesized on the display screen, and the display screen is displayed on the display surface 11c (task S206). On the transition screen 700, the display screen transitions to the selected screen.

According to the embodiment described in the context of discussion of FIG. 6, by means of an operation on the reduced image group R, which has been synthesized on the screen group P, the transition screen 700 is displayed. On the transition screen 700, the reduced image group R is displayed with a large size. By viewing the reduced image group R, the user may find a desired icon 500. With the reduced image group R having been enlarged, the icon 500 is also displayed with a large size, so the content of icon 500 is displayed in greater detail. For example, a shape of with icon 500 becomes clearer, colors are applied to with icon 500, the text of with icon 500 is displayed unabbreviated, etc. The user may more easily identify with icon 500, and may more effectively search for an application to be started up.

Furthermore, according to the embodiment described in the context of discussion of FIG. 6, in the transition screen 700, the reduced image group R is displayed so as to appear enlarged within a three-dimensional space. This kind of display mode may be considered excellent from a design perspective.

In an embodiment, the mobile phone 1 can use the reduced image group R to move the icon 500 disposed on a screen in the screen group P to another screen. The CPU 100, as a display control module, may display the icon 500 on the screen group P corresponding to the location of a touch by the user, in such a way that they move.

The CPU 100, as a run module, may determine a reduced image displayed at the location of the touch by the user, and processing indicated by the reduced image, and may run the determined processing. The CPU 100, as a run module, is operable to run processing corresponding to a selected icon 500, based on an input to select an icon 500 within the screen displayed on the display surface 11c being received by a touch sensor 12.

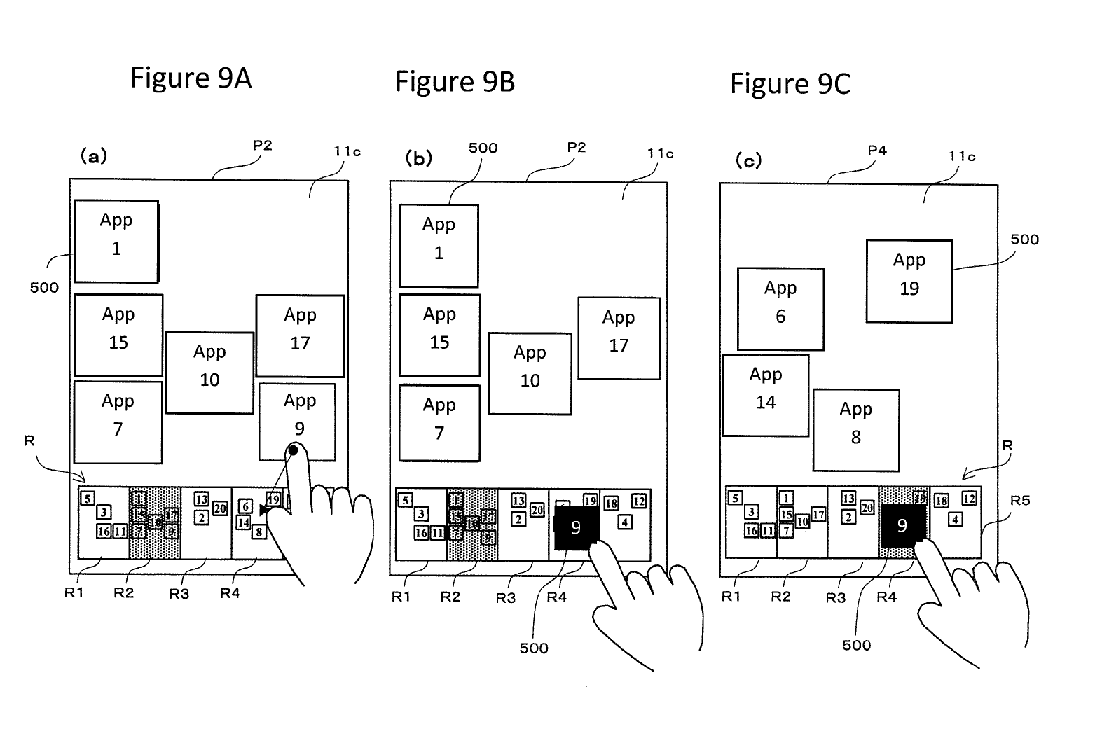

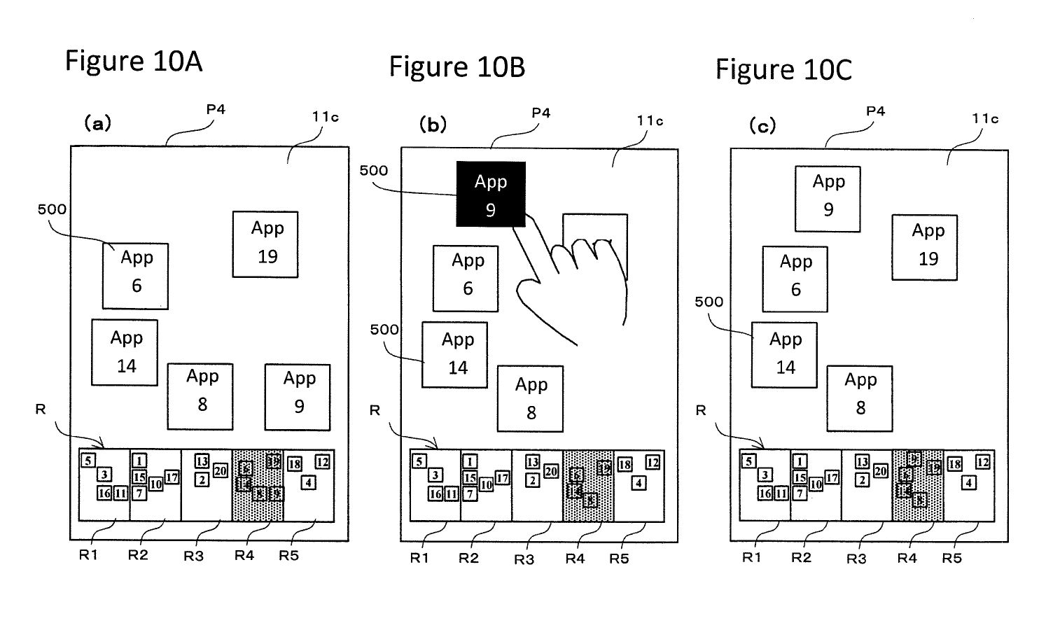

In particular, these are processing tasks may be used in the CPU 100, using the reduced image group, to reconfigure an integrated circuit (IC). FIG. 9 and FIG. 10 are illustrations of diagrams showing the reduced image group R is synthesized on a screen and displayed on a display surface according to an embodiment of the disclosure. In particular, FIG. 9A to FIG. 9C and FIG. 10A to FIG. 10C show screen groups that are displayed on the display surface 11c when the icons 500 are moved.

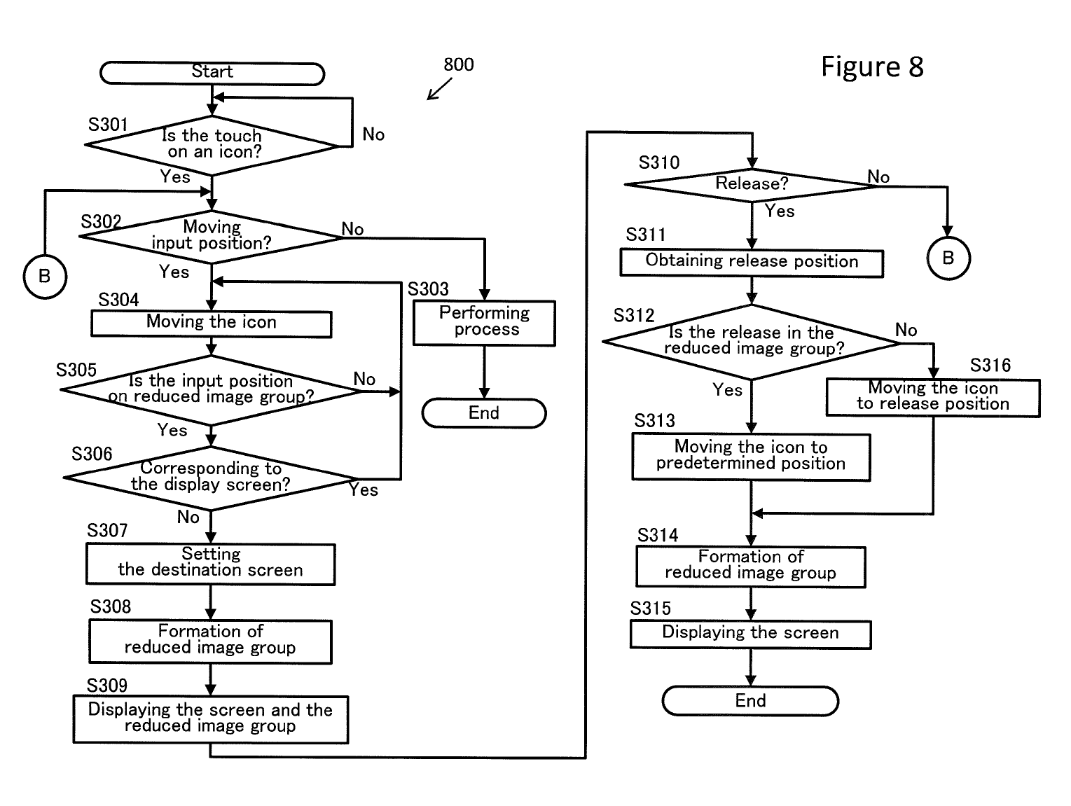

FIG. 8 is an illustration of a flowchart showing a process 800 for transition of the screen group P that can be performed by the CPU 100 according to an embodiment of the discloser. The various tasks performed in connection with the process 800 may be performed by software, hardware, firmware, a computer-readable medium having computer executable instructions for performing the process method, or any combination thereof. The process 800 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 800 may include any number of additional or alternative tasks, the tasks shown in FIG. 6 need not be performed in the illustrated order, and process 800 may be incorporated into a more comprehensive procedure or process having additional functionality not described in detail herein. In practical embodiments, portions of the process 800 may be performed by different elements of the system 200 such as: the CPU 100, the memory 200, the image decoder 301, the audio encoder 302, the communication module 303, the backlight drive circuit 304, the image decoder 305, the audio recorder 306, the clock 307, the backlight drive circuit 11a, the panel backlight 11b, the touch sensor 12, etc. Process 800 may have functions, material, and structures that are similar to the embodiments shown in FIGS. 1-6. Therefore common features, functions, and elements may not be redundantly described here.

As shown in FIG. 9A, the screen P2 is displayed on the display surface 11c. When the user touches the icon 500 of the screen P2 (task S301: YES), it is determined by the CPU 100, within a prescribed time interval, whether the location of the touch on the screen P2 is displaced or not (task S302). If the location of the touch does not change within the location of the touch prescribed time interval, the CPU 100 determines that the location of the touch icon 500 has been selected (task S302: NO). The CPU 100 runs the processing of the selected icon 500 (task S303).

As shown in FIG. 9A, when the user touch(finger) moves within the prescribed time interval from over the icon 500 of an “application 9” as shown by the arrow, the CPU 100 determines that the location of the touch has moved within the prescribed time interval (task S302: YES). In this way, the operation to move the icon 500 is performed, and the location of the icon 500 of the “application 9” is moved corresponding to the location of the touch (task S304).

When the user moves his/her touch (finger) from over the icon 500 to over the reduced image group R, the CPU 100 determines that location of the touch is within the range of the reduced image group R (task S305: YES). As shown in FIG. 9B, the icon 500 of the “application 9” moves together with the location of the touch and is displayed over the reduced image group R. Over the reduced image group R, the icon 500 is reduced to a size that fits the reduced image, along with which, in order to distinguish it from the reduced image group R, it is highlighted on the display surface 11c.

Additionally, the location of the touch within the reduced image group R is derived. In the embodiment shown in FIG. 9B, the CPU 100 determines that the location of the touch is in the reduced image R4 of the reduced image group R. The CPU 100 determines that the screen P4, corresponding to the reduced image R4, is the transition destination screen. If the CPU 100 determines that this determined transition destination screen matches the current display screen (task S306: YES), there is no need to transition the display screen, so once again, the movement of the icon 500 is monitored (task S304).

Otherwise, if the transition destination screen is different from the current display screen (task S306: NO), the CPU 100 sets the transition destination screen as a new display screen (task S307). Moreover, the CPU 100 forms the reduced image group R of the screen group P in the memory 200 (task S308). As shown in FIG. 9C, the icon 500 of the “application 9” move from the screen P2 to above the reduced image group R, so the icon 500 of the “application 9” are no longer displayed on the reduced image R2 of the reduced image group R. Moreover, the display screen changes from the screen P2 to screen P4, so CPU 100 displays the reduced image R4 corresponding to the screen P4, highlighted.

The CPU 100 synthesizes the reduced image group R, in which the reduced image R4 is highlighted on the display screen 11c, on the screen P4 (task S309). Here, the icon 500 of the “application 9” is displayed over the reduced image R4 of the reduced image group R.

During the time from when the user touches the display surface 11c until the touch is released from the display surface 11c, together with the screen group P being displayed, a location signal from the touch sensor 12 is monitored, and the location of the touch on the location signal is temporarily stored.

When a touch means such as a finger on the icon 500 of the “application 9” is separated from the display surface 11c, the location signal from the touch sensor 12 is not input to the CPU 100, so the CPU 100 determines that the finger has been released (task S310: YES). The CPU 100 obtains, from among the input/touch locations temporarily stored, the input/touch location immediately prior to the location signal input being lost, and sets it as a release location (task S311).

The CPU 100 then determines whether the release location is within the range of the reduced image group R (task S312).

As shown in FIG. 9C, if the finger above the reduced image group R is released from the display surface 11c (task S312: YES), as shown in FIG. 10A, the icon 500 moves to a prescribed location on the screen P4 (task S313). The icon 500 of the “application 9” is newly displayed on the screen P4, and the disposition of the icon 500 on the screen group P changes. The CPU 100 once again forms the reduced image group R of the screen group P (task S314), and the displays screen P4, on which the reduced image group R has been synthesized, on the display surface 11c (task S315). Consequently, the new disposition of the icon 500, such that the icon 500 of the “application 9” is displayed at a prescribed location on the screen P4, is reflected in the reduced image group R.

Otherwise, as shown in FIG. 10B, if the finger release location is outside of the reduced image group R (task S312: NO), the release location on the screen P4 is determined, and the icon 500 moves to the release location (task S316). In this way, the icon 500 of the “application 9” is displayed at a location on the screen P4 that has been specified by the user. For this reason, the reduced image group R of the screen group P is once again formed (task S314), and the screen P4, on which the reduced image group R is synthesized, is displayed on the display surface 11c (task S315).

In the above, according to the embodiment shown in FIG. 8, while viewing the reduced image group R, the user takes into consideration a type of the icon 500 displayed on each screen of the screen group P, and may select a screen that is redisplayed destination of the icon 500.

Moreover, by means of the user moving the icon 500 to a reduced image of the reduced image group R, the screen group P transitions to a screen corresponding to the reduced image to which the icon 500 is moved. For this reason, while moving the icon 500, the user may easily move the icon 500 to a target screen without going to the inconvenience of transitioning the screen group P.

After the icon 500 is moved to the reduced image group R, the user terminates the move operation by means of a release, following which the icon 500 is displayed at a prescribed location on the screen. The user is able to easily move the icon 500 to a desired screen.

After moving the icon 500 to the reduced image group R, the user moves the icon 500 still further to an area outside the reduced image group R, following which, by means of a release, the user terminates the move operation. The icon 500 is displayed at the release location, so the user is able to easily move the icon 500 to an arbitrary location on a desired screen.

In the embodiment shown in FIG. 6, when the reduced image group R is dragged, the transition screen 700 is displayed. The transition screen 700 may also be displayed, if an operation selecting the reduced image group R comprises a double click, etc.

In the embodiment shown in FIG. 8, when the finger is released above the reduced image group R, the icon 500 is displayed at the prescribed location on the display screen. Here, when the display screen is touched within the prescribed time interval starting from the release, the icon 500 may be moved to the touched location. The icon 500 is moved to the location desired by the user.

Also in the embodiment shown in FIG. 8, the icon 500, which is displayed on a screen in the screen group P is moved to another screen. As with the icon 500, for example but without limitation, widgets such as buttons, windows, text boxes, or other items displayed on the screen can also be moved. Examples of the widgets comprise, for example but without limitation, a calendar, a clock, weather information, or other widgets. Weather information, etc., may be obtained through a network.

In one embodiment, the screen group P is separated into the five screens, in another embodiment there is no need to separate screen group P. Moreover, each separated screen transitions, but this is not a limitation. For example, a screen can transition so that the range that comprises the user input location is displayed.

Moreover, in one embodiment, the reduced image group R is a reduced image, reducing all screens of the screen group P, but the reduced image group R may also be a reduced image reducing some of the screens in the screen group P. When there are many screens, and all the screens are reduced, the content of the reduced image group R may become too small, or the size of reduced image group R become too large, etc. For this reason, it is acceptable to reduce the display screen, and one or multiple screens adjacent to the display screen. In this way, the user is able to grasp the content of screens adjacent to the display screen, by means of the reduced image group R. Moreover, the display screen is displayed on the display surface 11c, so it is possible to reduce the display screen, and to reduce other screens. In this way, it is possible to display, with a large size, screens other than the display screen.

Additionally, in this embodiment, the location relationships table is used, but it is also possible to use a calculation formula associating the location on the reduced image group R and the location on the screen group P.

In an embodiment, images other than icons are displayed in the reduced image, but it is not necessary to display images other than icons in the reduced image. The processing load of displaying images is reduced, and images can be rapidly displayed. In the reduced image, the area in which the icon has been removed may be displayed semi-transparently, or a predefined image may be displayed. Predefined images comprise monochromatic images, etc.

In an embodiment, while the finger is touching the reduced image group R, it is also possible to modify the display mode, such as displaying the reduced image group R so that it appears to wobble, etc. When the display mode is modified in this way, it is easy to comprehend that screen group P is in a transition state.

In one embodiment, a part or all of the abovementioned embodiments may be combined.

In this document, the terms “computer program product”, “computer-readable medium”, and the like may be used generally to refer to media such as, for example, memory, storage devices, or storage unit. These and other forms of computer-readable media may be involved in storing one or more instructions for use by the CPU 100 to cause the CPU 100 to perform specified operations. Such instructions, generally referred to as “computer program code” or “program code” (which may be grouped in the form of computer programs or other groupings), when executed, enable a method for operating a system such as the mobile phone 1.

Terms and phrases used in this document, and variations hereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device comprising:
a display; and
a display control module operable to display a reduced image of a screen image comprising at least one icon on the display, the reduced image overlapping the screen image displayed on the display.

2. The mobile electronic device of claim 1, further comprising:
a sensor operable to receive a selection input selecting the reduced image from the display, wherein the display control module displays the screen image corresponding to the selected reduced image on the display, when the selection input is received by the sensor.

3. The mobile electronic device of claim 2, wherein:
the display control module is further operable to display on the display a first screen image corresponding to a first reduced image from among an image group comprising a plurality of images displayed on the display, and display the first screen image overlapping the image group on the display, when the first image is selected.

4. The mobile electronic device of claim 3, wherein:
the display control module is further operable to:
move the at least one icon according to a move operation, when an input to move the at least one icon within the first screen image is received by the sensor, and
display a second screen image corresponding to a second reduced image in place of the first screen image, when the at least one icon moves to a location of the second reduced image within the image group.

5. The mobile electronic device of claim 4, wherein:
the display control module locates the at least one icon at a prescribed location within the second screen, when an operation on the at least one icon terminates after the second screen image is displayed and the at least one icon is at the location of the second reduced image.

6. The mobile electronic device of claim 4, wherein:
the display control module locates the at least one icon at a screen location within the second screen image at which a move operation is terminated, when the second screen is displayed and an operation on the at least one icon terminates in the case that the at least one icon is within a range of the second screen that excludes the image group.

7. The mobile electronic device of claim 3, wherein:
the display control module displays the image group enlarged on the display, when a prescribed input on the image group is received by the sensor.

8. The mobile electronic device of claim 1, further comprising:
a run module operable to run processing corresponding to a selected icon, based on an input to select an icon within the screen displayed on the display being received by a sensor.

9. A method for operating a mobile electronic device, the method comprising:
displaying a reduced image of a screen image comprising at least one icon on a display; and
overlapping the reduced image on the screen image displayed on the display.

10. The method of claim 9, further comprising:
receiving a selection input selecting the reduced image from the display; and
displaying a selected screen image corresponding to the selected reduced image on the display, when the selection input is received.

11. The method of claim 10, further comprising:
displaying on the display a first screen image corresponding to a first reduced image from among an image group comprising a plurality of images displayed on the display, and displaying the first screen image overlapping the image group on the first screen, when the first reduced image is selected.

12. The method of claim 11, further comprising:
moving the at least one icon according to a move operation, when input to move the at least one icon within the first screen image is received by the receiving module, and
displaying a second screen image corresponding to a second reduced image, when the at least one icon moves to a location of the second reduced image within the image group in place of the first screen image.

13. The method of claim 12, further comprising:
locating the at least one icon at a prescribed location within the second screen image, when the second screen is displayed and an operation on the at least one icon terminates in the case that the at least one icon is at the location of the second image.

14. The method of claim 12, further comprising:
locating the at least one icon at a prescribed location within the second screen image at which an operation terminated, when, after the second screen image is displayed, an operation on the at least one icon terminates in the case that the at least one icon is within a range of the second screen image that excludes the image group.

15. The method of claim 11, further comprising:
displaying the image group enlarged on the display, when a prescribed input on the image group is received.

16. The method of claim 9, further comprising:
running processing corresponding to a selected icon, based on an input to select the at least one icon within the screen displayed on the display being received.

17. A computer readable storage medium comprising computer-executable instructions for performing a method for operating a display screen, the method executed by the computer-executable instructions comprising:
displaying a reduced screen image of a screen image comprising at least one icon on a display; and
overlapping the reduced image on the screen image displayed on the display.

18. The computer readable storage medium according to claim 17, the method executed by the computer-executable instructions further comprising:
receiving a selection input selecting the reduced image from the display; and
displaying a selected screen image corresponding to the selected reduced image on the display, when the selection input is received.

19. The computer readable storage medium according to claim 18, the method executed by the computer-executable instructions further comprising:
displaying on the display a first screen image corresponding to a first reduced image from among an image group comprising a plurality of images displayed on the display, and display the first screen image overlapping the image group on the first screen, when the first reduced image is selected.

20. The computer readable storage medium according to claim 19, the method executed by the computer-executable instructions further comprising:
moving the at least one icon according to a relevant move input, when input to move the at least one icon within the first screen image is received, and
displaying a second screen image corresponding to a second reduced image, when the at least one moves to a location of the second image within the image group in place of the first screen image.

21. A mobile electronic device comprising:
a display module operable to display a screen image comprising at least one icon; and
a display control module operable to cause the display module to display a reduced image of the screen and the screen image displayed on the display concurrently.
